(19) United States
(12) Patent Application Publication
(10) Pub. No.: US 2020/0305642 A1
(43) Pub. Date: Oct. 1, 2020

(54) FLUID OPTIMIZATION MECHANISMS FOR COOKING DEVICES

(71) Applicant: LIFETIME PRODUCTS, INC., Clearfield, UT (US)

(72) Inventors: Jeffrey D. Hancock, Uintah, UT (US); Christopher N. Schenck, Uintah, UT (US)

(21) Appl. No.: 16/833,589

(22) Filed: Mar. 28, 2020

Related U.S. Application Data
(60) Provisional application No. 62/826,723, filed on Mar. 29, 2019.

(51) Int. Cl. A47J 37/07; F24C 1/04; F24C 15/00; F24C 15/28

(52) U.S. Cl. CPC A47J 37/0713; F24C 15/28; F24C 15/001; F24C 1/04

(57) ABSTRACT

A cooking device may include a housing, a gas burner, an unburned gas vent assembly, and a vent. The unburned gas vent assembly may include a gutter disposed in the housing and at least a portion of the gutter may be disposed below at least a portion of the gas burner. The vent may be in fluid communication with an inner volume of the gutter to enable a gas disposed in the gutter to exit the housing via the vent. The gas burner may extend from the first portion of the housing to the second portion of the housing, the vent may be disposed in the second portion of the housing, and the gutter may be sloped from the first portion of the housing to the second portion of the housing.

### CROSS-REFERENCE TO RELATED APPLICATIONS

The present application claims priority to and the benefit of U.S. Provisional Patent Application Ser. No. 62/826,723, entitled FLUID OPTIMIZATION MECHANISMS FOR COOKING DEVICES, which was filed on Mar. 29, 2019, and is incorporated by reference in its entirety.

### BACKGROUND OF THE INVENTION

### Field of the Invention

The present invention generally relates to cooking devices, in particular, some embodiments of the present disclosure relate to fluid optimization mechanisms for cooking devices such as unburned gas vent assemblies and heat diffusers.

### Description of Related Art

Many different types of cooking devices are well known and used for a variety of different purposes. For example, some cooking devices may be implemented to cook foodstuffs in an outdoor environment such as a park, a yard, while camping, etc. The outdoor cooking devices generally combust a particular type of fuel to generate thermal energy, which is used to cook the foodstuffs. Examples of the types of fuel traditionally used to cook foodstuffs include propane gas, natural gas, charcoal, wood, etc. Most cooking devices are configured to burn a single type of fuel. For instance, charcoal grills are generally constructed with areas for charcoal briquettes and the charcoal briquettes are burned to create heat that is used to cook the foodstuffs.

Additionally, some cooking devices may be configured for multiple types of fuels. The multiple fuel type cooking devices are often comprised of two single-fuel type cooking devices connected in a side-by-side arrangement. For instance, an example of a duel-fuel cooking device is a gas grill positioned next to a charcoal grill. Such known duel-fuel cooking devices are generally much larger than comparable single-fuel type cooking devices. These known duel-fuel cooking devices do not improve the functionality of the cooking device. Instead, these known duel-fuel cooking devices merely provide a fuel option. Moreover, these duel-fuel type cooking devices often include multiple separate cooking volumes with multiple separate cooking surfaces. Accordingly, these duel-fuel type cooking devices are not well suited for a cooking operation involving multiple fuel types or involve the movement of foodstuffs between the separate cooking surfaces and cooking volumes during use.

The subject matter claimed herein is not limited to embodiments that solve any disadvantages or that operate only in environments such as those described. Rather, this background is only provided to illustrate one example technology area where some embodiments described herein may be practiced.

### BRIEF SUMMARY OF THE INVENTION

A need therefore exists for a cooking device which eliminates the above-described disadvantages and problems.

One aspect is a cooking device that may include multiple heat sources within a cooking volume. The heat sources may be different types of heat sources and may use different types of fuel. For example, the cooking device may include heat sources such as propane or gas-powered burners. The cooking device may also include heat sources such as a wood pellet stove. Advantageously, if the two heat sources are at least partially disposed within the same cooking volume, the cooking device may have a relatively small size and footprint.

Another aspect is a cooking device that may include multiple heat sources that heat the same cooking surface or area. Because multiple heat sources may heat the same cooking surface or area, different type of cooking fuels may be used. The multiple heat sources may also expand cooking operations and functions because foodstuffs may be cooked using different processes, techniques, and the like. For example, if the cooking device includes a wood pellet stove as a heat source and gas-powered burners as another heat source, then the cooking device may allow different types of cooking operations to occur independently, simultaneously, concurrently, and the like.

Still another aspect is a cooking device that may provide improved airflow, ventilation, and the like. For example, the cooking device may include one or more gutters disposed within a cooking volume. The gutters may allow unburned gas to be removed from the cooking volume. The gutters may also improve or provide more consistent airflow within the cooking volume. In addition, the gutters may prevent unintended airflow or fast-moving air currents from impacting the burners, which may prevent the burners from being unintentionally or inadvertently extinguished. The cooking device may also include one or more vents, openings, and the like to allow, for example, unburned gas to exit the cooking volume. The vents, openings, and the like may also provide more airflow to the heat sources, which may allow more complete combustion.

Yet another aspect is a cooking device that may include a diffuser. The diffuser may allow heat, smoke, and the like to be directed, guided, regulated, and/or managed within the cooking volume. For example, the diffuser may direct heat and/or smoke from a heat source, such as a wood pellet stove, within the cooking volume. The diffuser may be sized and configured to allow a particular type of cooking, such as smoking or grilling, to occur.

A further aspect is a cooking device that may include a housing, a gas burner, an unburned gas vent assembly comprising a gutter disposed in the housing and at least a portion of the gutter disposed below at least a portion of the gas burner, and a vent in fluid communication with an inner volume of the gutter to enable a gas disposed in the gutter to exit the housing via the vent. The housing may include a first portion and a second portion, the gas burner may extend from the first portion of the housing to the second portion of the housing, the vent may be disposed in the second portion of the housing; and the gutter may be sloped from the first portion of the housing to the second portion of the housing. The gutter may include a rounded portion, a first linear portion, and a second linear portion. The rounded portion of the gutter may be disposed below the gas burner. A radius of the rounded portion may increase from a first portion to a second portion; or a height of the first linear portion and the second linear portion may increases from the first portion to the second portion.

A still further aspect is a cooking device that may include a gutter assembly with at least one gutter. The gutter may include one or more attachment features. The one or more attachment features may include rear attachment features that extend towards one another from the first and second linear portions. The one or more attachment features may include front attachment features that extend towards one another from a portion of a front perimeter of the gutter that includes the first and second linear portions. If desired, the gas burner may be substantially centered between the first and second linear portions. A second portion of the housing may directly contact an end of the gutter such that gas is directed from the gutter to an environment outside the housing. The gutter may include a height that is at least three times a height of the gas burner.

Another further aspect is a cooking device that may include a first heat source, such as the gas burner. The cooking device may include a second heat source and the second heat source may be positioned below or directly below at least a portion of the gas burner, and the first heat source and the second heat source may be positioned within a volume defined by the housing. The cooking device may include a heat diffuser and the heat diffuser may be positioned between the gutter and the second heat source, and the heat diffuser may be configured to diffuse the heat produced by the second heat source throughout at least a portion of the housing. The second heat source may include a wood pellet burner, and the heat diffuser may include a substantially rectangular channel that partially surrounds the second heat source to direct smoke towards a left and a right portion of the housing from a central portion of the housing. The heat diffuser may include a length that is greater than about one-third of a length of the housing and less than one-half the length of the housing. The heat diffuser may include a width that is about one-half a width of the housing.

Still another further aspect is a cooking device that may include a housing, such as a vented housing, and the vented housing may include an upper portion and sloped lower portions that define a bottom vent subassembly. The bottom vent subassembly may include one or more apertures that surround a pellet stove support, and the apertures may be configured to enable fluid transfer between an internal volume of the vented housing and a surrounding environment. The cooking device may include an external tray and the external tray may be selectively retained relative to the vented housing via tray supports.

Still yet another further aspect is an unburned gas vent assembly for a cooking device that is configured to enable unburned gas to vent from a housing of the cooking device to an environment external to the housing. The assembly may include a gutter configured to be disposed in the housing of the cooking device, at least a portion of the gutter may be disposed below at least a portion of a gas burner such that unburned gas exiting the gas burner settles in the gutter, and a vent may be in fluid communication with an inner volume of the gutter to enable an unburned gas disposed in the gutter to exit the housing via the vent.

A further aspect is a cooking device including a vented housing went a bottom vent subassembly and one or more heat sources disposed in the vented housing. A first heat source may include a wood pellet stove and the vented housing may enable fluid transfer from an internal volume defined by the vented housing and a surrounding the cooking device.

These and other aspects, features and advantages of the present invention will become more fully apparent from the following brief description of the drawings, the drawings, the detailed description of preferred embodiments and appended claims.

### BRIEF DESCRIPTION OF THE DRAWINGS

The appended drawings contain figures of exemplary embodiments to further illustrate and clarify the above and other aspects, advantages and features of the present invention. It will be appreciated that these drawings depict only exemplary embodiments of the invention and are not intended to limit its scope. Additionally, it will be appreciated that while the drawings may illustrate preferred sizes, scales, relationships and configurations of the invention, the drawings are not intended to limit the scope of the claimed invention. The invention will be described and explained with additional specificity and detail through the use of the accompanying drawings in which:

FIG. 1A illustrates an exemplary cooking device;

FIG. 1B is another view of the exemplary cooking device shown in FIG. 1A;

FIG. 2A is a sectional view of a portion of the exemplary cooking device shown in FIGS. 1A and 1B, illustrating an exemplary unburned gas vent assembly (vent assembly);

FIG. 2B is another sectional view of a portion of the exemplary cooking device shown in FIGS. 1A and 1B, illustrating another view of the exemplary vent assembly;

FIG. 3A is an enlarged view of a portion of the exemplary vent assembly;

FIG. 3B is another enlarged view of a portion of the exemplary vent assembly;

FIG. 4A illustrates an exemplary gutter assembly and the gutter assembly may be used in connection with the exemplary vent assembly shown in FIGS. 2A and 2B, or another cooking device;

FIG. 4B illustrates another view of the exemplary gutter shown in FIG. 4A;

FIG. 4C illustrates another view of the exemplary gutter shown in FIG. 4A;

FIG. 5 illustrates an exemplary heat diffuser and the heat diffuser may be implemented in the cooking device shown in FIGS. 1A and 1B, or another cooking device;

FIG. 6A illustrates an exemplary vented housing and the vented housing may be implemented in the cooking device shown in FIGS. 1A and 1B, or another cooking device;

FIG. 6B illustrates another view of the exemplary vented housing shown in FIG. 6A;

FIG. 6C illustrates another view of the exemplary vented housing shown in FIG. 6A; and

FIG. 6D illustrates another view of the exemplary vented housing shown in FIG. 6A.

### DETAILED DESCRIPTION OF SOME EXEMPLARY EMBODIMENTS

The present invention is generally directed towards cooking devices. The cooking devices may include one or more heat sources and the heat sources may be disposed in a stacked configuration and/or arrangement. The principles of the present invention, however, are not limited to cooking devices, cooking devices with multiple heat sources, or cooking devices with heat sources disposed in a stacked configuration. It will be understood that, in light of the present disclosure, the cooking devices, and components and features of the cooking devices, may be successfully used in connection with other types of structures and devices.

Additionally, to assist in the description of the exemplary cooking devices, words such as top, bottom, front, rear, right, and left may be used to describe the accompanying figures. It will be appreciated that the cooking devices can be disposed in other positions, used in a variety of situations, and may perform a number of different functions. In addition, the drawings may be to scale and may illustrate various exemplary configurations, arrangements, aspects, and features of the cooking devices. It will be appreciated, however, that the cooking devices may have other suitable shapes, sizes, configurations, and arrangements depending, for example, upon the intended use of the cooking devices. Further, the cooking devices may include any suitable number or combination of components, aspects, features and the like. A detailed description of exemplary embodiments of the cooking devices now follows.

By the term “substantially” it is meant that the recited characteristic, parameter, or value need not be achieved exactly, but that deviations or variations, including for example, tolerances, measurement error, measurement accuracy limitations and other factors known to one skill in the art, may occur in amounts that do not preclude the effect the characteristic was intended to provide.

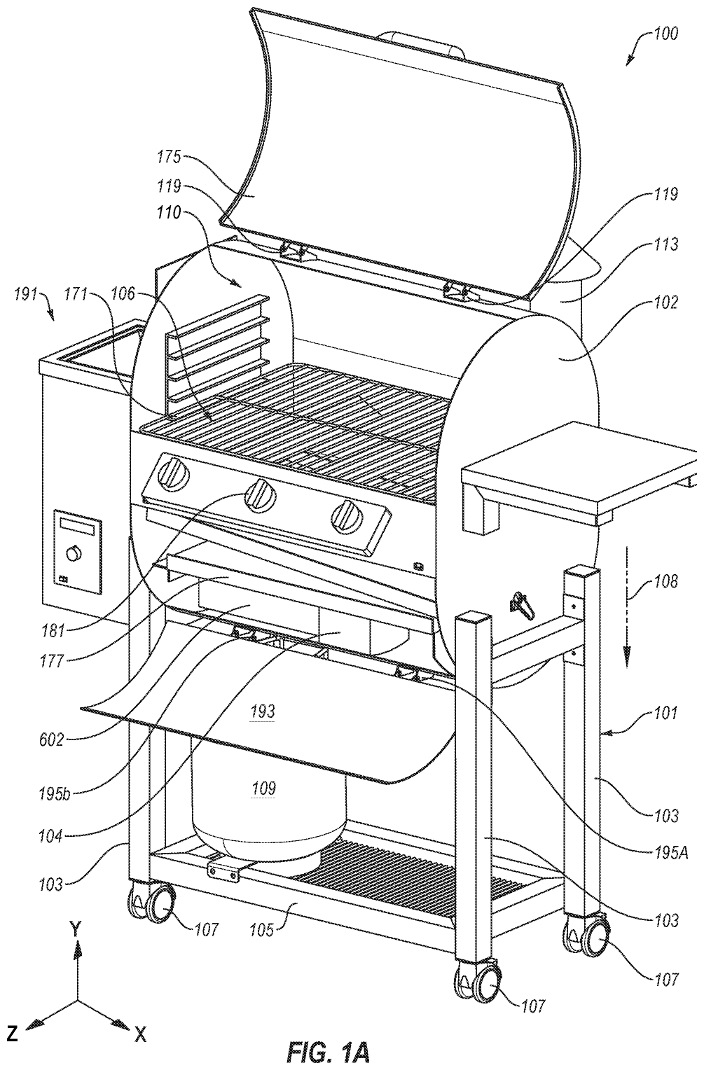

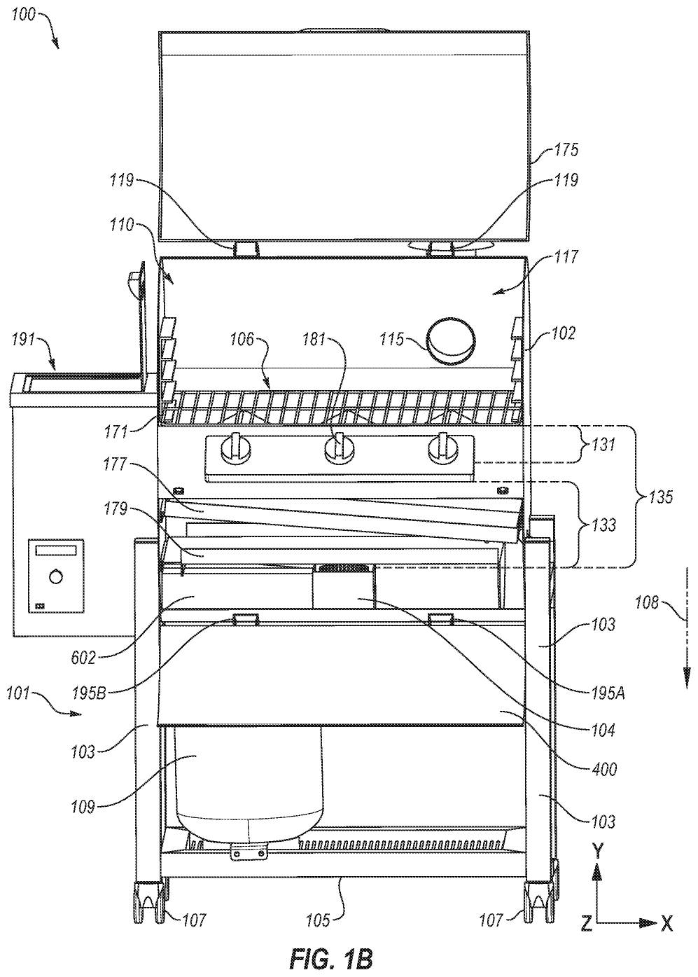

FIGS. 1A and 1B illustrate an exemplary cooking device 100 in which one or more embodiments of the present disclosure may be implemented. As described below, the cooking device 100 may include a housing 102 and one or more heat sources, such as heat sources 104 and 106. If desired, the one or more of the heat sources may be disposed in a stacked arrangement. In addition, the one or more heat sources may be disposed within the same structure, such as an integrated volume 110, and the integrated volume may be at least partially defined by the housing 102. In some exemplary embodiments, the heat source 104 may include a wood pellet stove and the wood pellet stove may include a burner, burner box, or burn pot where the pellets are burned. The heat source 106 may include a burner, such as a gas burner, and the gas burner may combust a gas such as propane or natural gas. At least a portion of the heat source 104 may be combined with at least a portion of the heat source 106. For example, the gas burner of the heat source 106 and the burn pot of a wood pellet stove from the heat source 104 may be combined. In an exemplary embodiment, the gas burner of the heat source 106 and the burn pot of the wood pellet stove may be disposed within the same volume, such as the volume 110. In these and other exemplary embodiments, a portion of the heat source 106, such as the burn pot of the wood pellet stove, may be positioned directly below at least some portion or component of the heat source 104, such as the gas burner. After reviewing this disclosure, one of ordinary skill in the art will appreciate that the cooking device 100 may include other heat sources, use other types of heat sources, and the heat sources may be disposed in other suitable arrangements and/or configurations. For example, the heat source 104 does not have to be vertically stacked with the heat source 106, and the heat sources 104, 106 may be offset and/or disposed in other suitable arrangements and configurations.

The arrangement of multiple heat sources in the same housing may create one or more problems. For instance, disposing multiple heat sources in the same housing may introduce problems in certification of the cooking device, safety issues, etc. For example, if the gas burner is positioned at least partially above or directly above the burn pot of a wood pellet stove, a safety issue may be introduced. For illustrative purposes, if a flame of the gas burner is unintentionally extinguished, unburned gas may continue to be introduced into the volume. This may allow unburned gas to accumulate in the volume. After the unburned gas is accumulated, lighting the wood pellet stove, opening a lid, or other actions may result in rapid combustion of the accumulated unburned gas. The rapid combustion (which may be referred to as “flash back” or “flash fire”) may burn a user or may cause an explosion, which may damage surrounding structures and/or the cooking device. Accordingly, some exemplary embodiments of the present disclosure may include an unburned gas vent assembly. The unburned gas vent assembly may vent unburned gas from the volume, which may reduce the likelihood of rapid combustion of the unburned gas.

Additionally, the arrangement of multiple heat sources in a cooking device may make disassembling and cleaning the components of the cooking device difficult. For instance, in order to certify some cooking devices with a drip tray, the drip tray must be removable. The cooking device 100 may include a drip tray and the drip tray may be removable, which may allow some certification standards to be met. In the exemplary cooking device 100 shown in the accompanying figures, the positioning of the heat sources 104 and 106 in the volume 110 may result in difficulty accessing the drip tray. Accordingly, as described in more detail below, the cooking device 100 may include a lower door and the lower door may provide access to the drip tray.

The cooking device 100 may be configured to enhance ventilation of the volume 110. The enhanced ventilation may reduce production of carbon monoxide. For example, enhanced ventilation may improve combustion by allowing more airflow to the heat sources, which may reduce production of carbon monoxide or other gases. The enhanced ventilation may also allow more complete combustion of the fuel.

The arrangement of multiple heat sources within a cooking device may create issues such as inadvertently smothering or extinguishing a flame produced by the gas burner. For instance, the wood pellet stove may implement a high flow fan, which may be used to introduce air into a portion of the wood pellet stove. The introduced air may smother or put out the flame of the gas burner. Accordingly, exemplary embodiments of the present disclosure may include an unburned gas vent assembly and the unburned gas vent assembly may at least partially surround one or more of the burners. The unburned gas vent assembly may direct air around the burners. Some additional details of the exemplary cooking device 100 are provided below.

FIG. 1A is an upper perspective view of the exemplary cooking device 100. FIG. 1B is a front view of the cooking device 100. The cooking device 100 may include multiple heat sources, such as the heat source 104 and the heat source 106. The heat sources 104 and 106 may be arranged in a stacked arrangement in which heat sources 104 and 106 are separated from one another in substantially a single direction, such as a vertical direction. For example, the heat sources 104 and 106 may be arranged in the cooking device 100 such that the heat source 106 is separated from the heat source 104 by a particular distance in a particular direction, such as a first direction 108. The first direction 108 may be substantially parallel to the y-direction in the arbitrarily defined coordinate system of FIGS. 1A and 1B.

The stacked arrangement may include a disposition of the heat source 106, which may be better suited for high-heat cooking processes, close to a cooking grid 171. The cooking grid 171 may be configured for foodstuff placement and the cooking grid 171 may be sized and configured to support one or more cooking utensils or tools such as pots, pans, and the like. The stacked arrangement may include a disposition of the heat source 104, which may be better suited for low-heat cooking processes, farther from the cooking grid 171. Accordingly, the cooking device 100 may enable high-heat operations by the heat source 106 and/or low-heat operations by the heat source 104. The cooking device 100 may also enable cooking operations that involve both heat sources 104 and 106. In an exemplary embodiment, the cooking device 100 may allow the heat sources 104 and 106 to be used independently, concurrently, and/or simultaneously. For example, the cooking device 100 may enable faster cooking operations by using the heat source 106, which may reach a higher temperature sooner, and slower cooking operations by using the heat source 104, which may take longer to heat the cooking grid 171. One of ordinary skill in the art, after reviewing this disclosure, will appreciate that the heat source 106 may allow low-temperature and/or slower cooking operations, and the heat source 104 may allow high-temperature and/or faster cooking operations, depending, for example, upon the intended use of the cooking device 100. Some additional details of the cooking operations involving one or both heat sources 104 and 106 are described elsewhere in the present disclosure.

The heat sources 104 and 106 may be both positioned in a single, integrated volume 110 and the volume may be defined by the housing 102 of the cooking device 100. If desired, the heat sources 104 and 106 may be disposed in a generally vertically stacked configuration. The inclusion of the heat sources 104 and 106 in the volume 110 in the stacked arrangement may reduce an overall footprint of the cooking device 100 relative to other cooking devices that define multiple, separate cooking volumes that are arranged in side-by-side or vertical configurations. For instance, a conventional cooking device may include a gas grill in a first cooking volume that is positioned to one side of a second cooking volume that implements a charcoal grill. Such side-by-side arrangement may result in an increased footprint and limit concurrent operations of this conventional cooking device. The cooking device 100, however, may include the heat sources 104 and 106 positioned in the volume 110 in a vertically stacked configuration and that may advantageously reduce the number and/or amount of materials and components used to construct the cooking device 100. Thus, the cooking device 100, which may include the stacked arrangement of the heat sources 104 and 106 in the volume 110, may enable additional cooking processes because either or both heat sources 104 and 106 may be used independently and/or concurrently. The cooking device 100 with the stacked arrangement of the heat sources 104 and 106 may have a reduced size or footprint in comparison to conventional cooking devices with a side-by-side arrangement.

As shown in the accompanying figures, the cooking device 100 may include a base structure 101 or another support structure and the housing 102 may be mechanically coupled to the base or support structure. For instance, the housing 102 may be welded to or otherwise mechanically coupled to an upper portion of the base structure 101. The base structure 101 may be configured to retain the housing 102 above a surface such as a floor or the ground. The base structure 101 of FIGS. 1A and 1B may include vertical supports 103 and the vertical support may be connected to a lower platform 105 and to the housing 102. Casters 107 may be positioned at lower ends of the vertical supports 103, which may enable movement of the cooking device 100. A portion of the base or support structure 101, such as the lower platform 105, may be configured to support a gas tank 109 relative to the housing 102. For instance, in exemplary embodiments in which the heat source 106 includes a gas grill, the gas tank 109 may be coupled to the gas grill to provide gas during operation.

The base structure 101 shown in FIGS. 1A and 1B includes the four vertical supports 103, the four casters 107, and the lower platform 105. In other embodiments, the base structure 101 may include a cabinet below the housing 102, any suitable number of the casters 107, multiple lower platforms 105, and other variations. In addition, in other embodiments, the cooking device 100 may not include the base structure 101. For instance, the cooking device 100 may be integrated into an outdoor kitchen or another structure, which may not be configured for movement. For instance, the housing 102 and/or one or more other components of the cooking device 100 may be installed in a concrete or brick structure, installed on a patio, or installed in a backyard of a user. After reviewing this disclosure, one of ordinary skill in the art will appreciate that the cooking device 100 may have other base or support structures, and the base or support structures may have different shapes, sizes, configurations, and/or arrangements depending, for example, upon the intended use of the cooking device 100.

The cooking device 100 may include a feed subsystem 191. The feed subsystem 191 may temporarily store and feed fuel to a heat source, such as the heat source 104. For instance, the heat source 104 may include a wood pellet stove. Accordingly, in these exemplary embodiments, the feed subsystem 191 may include a wood pellet feed subsystem that stores wood pellets and feeds the wood pellets to the heat source 104 during at least some cooking operations. As used in the present disclosure, wood pellets may include any compressed biofuel, which may be used as a fuel source. The wood pellets may comprise biomass, and the wood pellets may at least be partially comprised of wood. The wood pellets may emit heat and/or smoke during combustion. It will be understood that the heat source 104 may use other appropriate fuel sources and wood pellets are an example of a fuel source that may be used.

The feed subsystem 191 may be mechanically coupled to the housing 102 and may include portions that extend into a lower portion of the volume 110. For instance, the feed subsystem 191 may include an auger conduit 602 and the auger conduit may extend into the volume 110. The auger conduit 602 may be connected to the heat source 104.

The cooking device 100 may include a vent conduit 113 such as shown in FIG. 1A. The vent conduit 113 may be fluidly coupled to the volume 110, which may be defined by the housing 102, and the vent conduit may be fluidly coupled to the volume 110 by a vent opening 115 such as shown in FIG. 1B. The vent opening 115 may be defined or disposed in a rear portion 117 of the housing 102. The vent conduit 113 may connect at least a portion of the volume 110 to an ambient environment, which may be an environment outside the volume. For instance, in some exemplary embodiments, the heat source 104 may include a wood pellet stove or burner. During operation, the vent conduit 113 may provide a path to vent smoke to the ambient environment, which may be the environment surrounding the cooking device 100.

The housing 102 may include an upper lid 175 and a lower door 193. The upper lid 175 and the lower door 193 may make up portions of the housing 102. The upper lid 175 and the lower door 193 may also make up portions of the volume 110. The upper lid 175 and the lower door 193 may make up portions of the housing 102 and/or the volume 110 when the lid and/or the door are in the closed position. In FIGS. 1A and 1B, the upper lid 175 and the lower door 193 are depicted in an open position. In the open position, internal surfaces of the housing 102 and various components (e.g., 171, 104, 106, 177, 179, etc.) may be accessed. For example, with the upper lid 175 in the open position, foodstuffs may be placed on and removed from the cooking grid 171. Additionally, with the lower door 193 in the open position, the heat source 104 may be accessed to be cleaned, maintained, repaired, and the like.

The upper lid 175 may be rotatably coupled to a rear upper portion of the housing 102 via upper hinges 119. The upper lid 175 may rotate about the upper hinges 119 between the open position and the closed position. In the closed position, the upper lid 175 may enclose an upper portion of the housing 102 and/or at least substantially seal the upper portion of the housing 102 relative to the ambient environment.

Similarly, the lower door 193 may be rotatably coupled to a bottom portion of the housing 102 via lower hinges 195A and 195B (generally, lower hinge 195 or lower hinges 195). The lower hinges 195 may rotatably connect the lower door 193 to the housing 102. The lower door 193 may rotate about the lower hinges 195 between the open position and the closed position. In the closed position, the upper lid 175 may enclose a lower portion of the housing 102 and/or at least substantially seal the lower portion of the housing 102 relative to the ambient environment.

As best depicted in FIG. 1B, the cooking device 100 may include one or more components such as the heat source 104, the heat source 106, the cooking grid 171, a baffle 177, and a drip tray 179, or some combination thereof. One or more of these components may be positioned in the volume 110. As introduced above, the heat sources 104 and 106 may be disposed in an at least substantially vertically stacked arrangement. For instance, the heat source 106 may be separated from the cooking grid 171 by a first distance 131 and the heat source 104 may be separated from the cooking grid 171 by a second distance 135. The second distance 135 may be greater than the first distance 131, and the heat source 106 may be closer to the cooking grid 171 than the heat source 104. One of ordinary skill in the art will understand after reviewing this disclosure that the heat sources 104 and 106 may be disposed in other arrangements and configurations, and the heat sources 104 and 106 may be spaced different distances from the cooking grid 171, depending, for example, upon the intended use of the cooking device 100.

The heat source 106 may include a first type of heat source such as a gas burner (e.g., a low pressure gas burner such as propane burner or natural gas burner) that may be used for high-heat (e.g., greater than about 350 degrees Fahrenheit (F)) and/or direct cooking processes. For instance, the heat source 106 may include a high-heat source relative to the heat source 104, which may provide a low-heat source. The heat source 106 may also be used for cooking processes that involve direct heating (e.g., grilling, searing, blackening, etc.) foodstuffs placed on the cooking grid 171 or otherwise disposed in the volume 110. While the heat source 106 may be used for high-heat cooking operations, it will be appreciated that the heat source 106 may also be used for low-heat cooking operations.

The heat source 104 may include a second type of heat source such as a wood pellet stove or burner, which may be implemented for low-heat (e.g., lower than about 350 degrees F.) and/or indirect cooking processes. For instance, the heat source 104 may be used for cooking processes such an indirectly heating (e.g., smoking, warming, slow cooking, etc.) foodstuffs placed on the cooking grid 171 or otherwise disposed in the volume 110. It will be appreciated that the heat source 104 may also be used for high-heat cooking operations.

The heat source 104 and the heat source 106 may be usable independently. For instance, the heat source 104 may be operated while the heat source 106 is not operational and vice versa. In addition, the heat source 104 and the second heat source 106 may be usable concurrently and/or in some combination during one or more cooking processes. Use of the heat sources 104 and 106 together may reduce fuel use and/or may reduce time involved in the cooking process when compared to a similar process performed by conventional cooking devices. Use of the heat sources 104 and 106 concurrently may also allow increase functionality of the cooking device 100. Further, because different heat sources 104 and 106 may directly and/or indirectly cook foodstuffs on the cooking grid 171, without requiring any movement of the foodstuffs, the cooking device 100 may be useful in many different environments and may be used for a variety of purposes.

For instance, an example smoking process may involve heating the volume 110 to about 225 degrees F. or another suitable temperature. After the volume is about 225 degrees F, foodstuff may be placed on the cooking grid 171. The volume 110 may be maintained at about 225 degrees F. for several hours while the foodstuff cooks. During at least a portion of the several hours, smoke may be introduced and maintained in the volume 110. After the several hours, the foodstuff may be finished by searing the foodstuff. The cooking device 100 may be used to implement this example cooking and smoking process. For instance, the heat source 106 may be used to heat the volume 110 to the 225 degrees F. Because the heat source 106 may include burners and may be similar to a gas grill, the volume 110 may be quickly heated to a given temperature. In addition, the heat source 106 may heat the volume 110 at a higher rate than the heat source 104. This may allow the volume 110 to be quickly and efficiently heated to a desired temperature. After the volume 110 is heated to a given temperature, the heat source 104 may be implemented to provide smoke and/or at least a portion of heat used to maintain the desired temperature. As discussed above, the heat source 104 may be used to indirectly provide heat. In this exemplary embodiment, the heat provided by the heat source 106 may be reduced to supplement the heat supplied by the heat source 104 (or vice versa). The heat provided by the heat source 106 may also be eliminated, if desired. Accordingly, the amount of fuel used by the heat source 106 and/or the heat source 104 may be reduced. The heat source 104 may be turned off when smoke and/or indirect heating is no longer desired to be introduced to the volume 110. In an exemplary embodiment, the heat source 106 may be used to maintain or increase the temperature for the remainder of the several hours. After the several hours, the heat supplied directly by the heat source 106 may be increased to finish cooking the foodstuffs, if desired. During the cooking process implemented by the cooking device 100, the foodstuff may remain on the cooking grid 171. The user may simply use the heat sources 104 and 106 to cook the foodstuffs, and the heat provided to the volume 110 may be provided by the heat sources 104 and 106. Additionally, during the cooking process the upper lid 175 and the lower door 193 may be maintained in the closed positions. Consequently, thermal losses to the environment may be reduced or at least substantially prevented. Thus, the cooking process implemented by the cooking device 100 may reduce or eliminate a need to move the foodstuffs from one cooking device or one cooking area to another. The cooking device 100 may also provide other benefits such as decreasing the long periods of wait time while a low-temperature heat source is used to heat the volume. For example, a high-temperature heat source may be used to heat the volume to a desired temperature and then the low-temperature heat source may be used to maintain the volume at a desired temperature. The high-temperature heat source could also be used to sear or seal foodstuffs while the low-temperature heat source could be used for smoking and/or slow cooking of foodstuffs. After reviewing this disclosure, one of ordinary skill in the art will appreciate that the cooking device 100 may have multiple purposes and functions depending, for example, upon the intended use of the cooking device.

The baffle 177 and the drip tray 179 may be positioned between the heat sources 104 and 106. For instance, the baffle 177 may be disposed between the heat source 104 and the heat source 106. The baffle 177 may be configured to direct at least a portion of the thermal energy produced by the heat source 104 to outer portions of the volume adjacent the housing 102. The thermal energy produced by the heat source 104 may transfer to an upper, first portion of the volume 110. The baffle 177 may be substantially flat as shown in FIG. 1B or may include at least one portion that is angled relative to the first direction 108.

The drip tray 179 may be positioned between the baffle 177 and the heat source 106. The drip tray 179 may be angled relative to the first direction 108. The drip tray 179 may be configured to collect fluids dripping from foodstuffs during operation. The fluids may proceed down the drip tray 179 and may exit the housing 102 via a funnel 161, such as shown in FIG. 1A or other suitable process.

The cooking grid 171, which is introduced above, may include a lattice or web of thermally conductive materials (e.g., metal, ceramic, etc.). The cooking grid 171 shown in FIGS. 1A and 1B may include horizontal and vertical elements that are arranged relative to one another in a plane. In other embodiments, the cooking grid 171 may include a solid surface or a substantially solid plane with one or more openings. The cooking grid 171 may be removable from the housing 102 and/or may be moved farther or closer to the heat sources 104 and 106, as desired. The cooking grid 171 may include a cooking surface sized and configured for placement of foodstuffs. The cooking grid 171 may also be sized and configured to hold or support cooking utensils or tools such as pots, pans, and the like.

In the exemplary embodiment depicted in FIGS. 1A and 1B, the heat source 106 may include a low-pressure gas grill or a gas heat source. The gas heat source may be controllable via one or more valves 181, which may be manual valves. The gas heat source may include three or more burners and the burners may extend from a front of the housing 102 to a rear of the housing 102. The burners may be covered by heat tents, which may distribute heat supplied by the burners and/or reduce an amount of fluids dripping on the burners. The gas heat source 106 may be positioned in the housing 102 such that thermal energy emitted from the gas heat source 106 is distributed across at least substantially all the cooking grid 171 and/or substantially all the rectangular cross section that is configured to receive the cooking grid 171. The gas heat source 106 may be positioned the first distance 131 (as shown in FIG. 1B) from the cooking grid 171 in the first direction 108. The first distance 131 may be measured from a top of the heat tents to a bottom of the cooking grid 171, the top of the burners to the bottom of the cooking grid 171, etc. The first distance 131 may be in a range of between about one inch and about six inches. The gas heat source may be arranged to heat the cooking grid 171 and an upper portion of the volume 110 via convection. Once heated, the cooking grid 171 may transfer thermal energy via conduction to foodstuffs placed on the cooking surface and may radiate thermal energy. The gas heat source 106 may further supply thermal energy to an upper portion of the volume 110 via convention and radiation. In other embodiments of the cooking device 100, other heat sources may be implemented as the heat source 106. Additionally, or alternatively, the gas heat source 106 may include any number of burners and/or heat tents, and the gas heat source may be automatically controlled. The number and size of the burners and/or heat tents may depend, for example, upon the size, shape, configuration, and/or arrangement of the cooking device 100.

In the exemplary embodiment shown in FIGS. 1A and 1B, the heat source 104 may include a wood pellet heat source that is configured for combustion of wood pellets. The wood pellet heat source may be arranged to provide thermal energy to the housing 102 and indirectly to foodstuffs placed on the cooking grid 171. Indirect heating generally indicates that an environment of the foodstuffs is heated, which in turn heats the foodstuffs. Direct heating generally indicates that the thermal energy is applied directly to the foodstuffs without necessarily heating an environment surrounding the foodstuffs.

The heat source 104, which is wood pellet heat source in this exemplary embodiment, may be positioned below an interior part of the heat source 106, which may be a gas heat source. If desired, the wood pellet heat source may be disposed in the lower portion of the volume 110. The wood pellet heat source 104 may be separated from the gas heat source 106 by the distance 133 and separated from the cooking grid 171 by the distance 135 in the first direction 108. The distance 133 may be measured from a bottom surface of the burner to a top of the wood pellet heat source 104. In an exemplary embodiment, the distance 133 may be between about seven inches and about twenty inches, but the distance 133 could be smaller or larger depending, for example, upon the intended use of the cooking device 100. The second distance 135 may be measured from a top of the wood pellet heat source 106 to a bottom surface of the cooking grid 171. The second distance 135 may be in a range between about nine and about twenty-nine inches, but the distance 135 could be smaller or larger depending, for example, upon the intended use of the cooking device 100. The wood pellet heat source 106 may be positioned in a middle part of the volume 110 and may be positioned directly below a central burner of the gas heat source 104. In other embodiments of the cooking device 100, other heat sources may be implemented as the heat source 104 and/or the heat source 106.

The heat source 106, which is a gas heat source in this exemplary embodiment, may supply a high-heat and/or direct heat to the cooking grid 171 and the volume 110. For instance, the valves 181 may be opened, which provides or increases gas supplied to the gas heat source 106. As a result, the gas heat source 106 may supply thermal energy at a high temperature (e.g., about 15,000 British thermal units per hour (BTU/H) to about 60,000 BTU/H) to the volume 110 and the cooking grid 171. In an exemplary embodiment, the gas heat source 106 may be configured to bring the volume 110 to a particular temperature (e.g., 300 degrees F.) at a first heat rate. The wood pellet heat source 104 may provide thermal energy indirectly to volume 110. The wood pellet heat source 104 may operate at a lower temperature than the gas heat source 106 and the wood pellet heat source 104 may be capable of heating the volume 110 to a particular temperature at a second rate, which may be less than the first heat rate.

In some embodiments, the cooking device 100 may be as described in U.S. application Ser. No. 16/001,921, which is incorporated herein by reference in its entirety.

After reviewing this disclosure, one of ordinary skill in the art will understand that modifications, additions, or omissions may be made to the cooking device 100 without departing from the scope of the present disclosure. Moreover, the separation of various components in the embodiments described herein is not meant to indicate that the separation occurs in all embodiments and the various components may be separated by different distances, if desired. Moreover, one of ordinary skill in the art will understood with the benefit of this disclosure that one or more of the components may be integrated together in a single component or separated into multiple components.

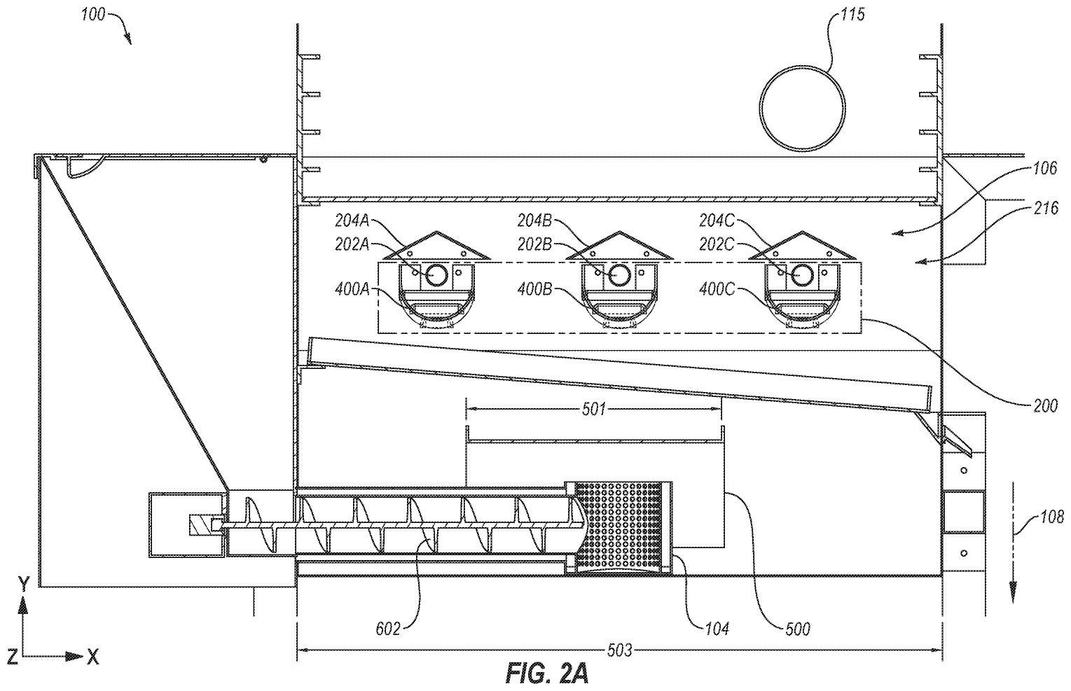

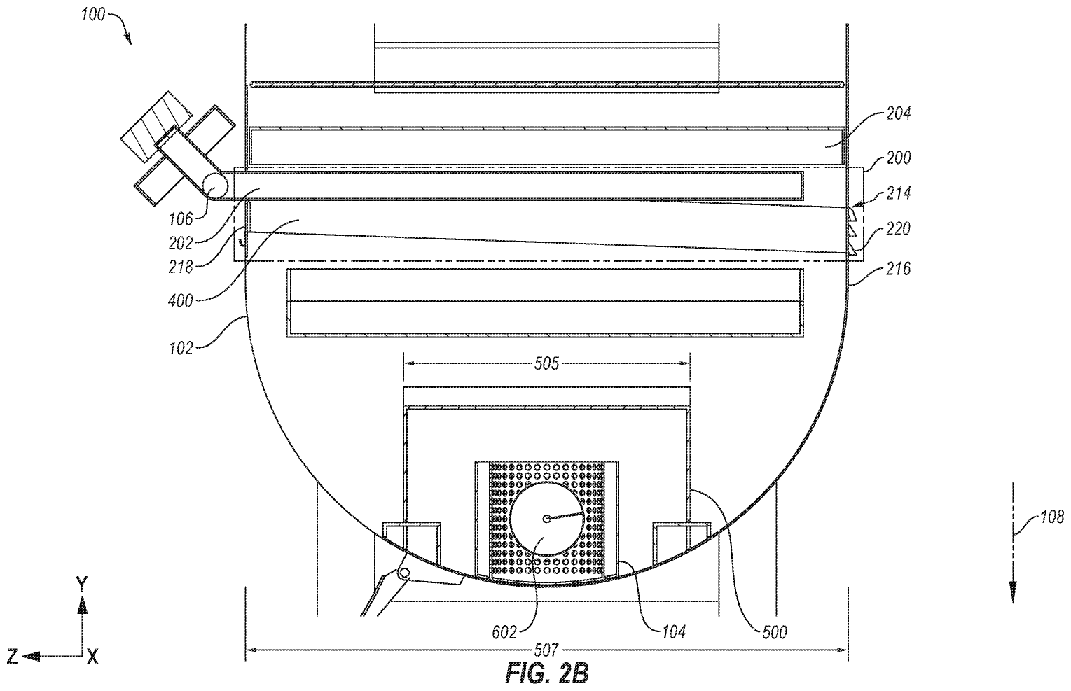

FIGS. 2A and 2B are sectional views of the cooking device 100 shown in FIGS. 1A and 1B. FIG. 2A is a sectional view across a plane that is substantially parallel to the XY plane of FIGS. 1A and 1B. FIG. 2B is a sectional view across a plane that is substantially parallel to the ZY plane of FIGS. 1A and 1B. In FIGS. 2A and 2B, the lid 175 and the base structure 101 are not depicted.

In FIGS. 2A and 2B, the heat source 106 may be the gas burner described above. The gas burner may include three burners 202A-202C (generally, burner 202 or burners 202). In other embodiments, the gas burner may include more than three burners 202 or fewer than three burners 202. Additionally, in the depicted exemplary embodiment, each of the burners 202 is covered by a heat tent 204A-204C (generally, heat tent 204 or heat tents 204). In other embodiments, one or more of the burners 202 may not be covered by one of the heat tents 204. Additionally, in some embodiments one of the tents 204 may be configured to cover two or more of the burners 202.

In FIGS. 2A and 2B, the heat source 104 may be the wood pellet stove or burner. The heat source 104 may be positioned below or directly below the heat source 106. For instance, the heat source 104 may only be separated from the heat source 106 in the first direction 108. If the heat source 104 is a wood pellet stove, the heat source 104 may burn wood pellets that are fed from the reservoir 210 shown in FIG. 2A to a burner 212 via the auger conduit 602.

In FIGS. 2A and 2B, an example unburned gas vent assembly (vent assembly) 200 is depicted. The vent assembly 200 may be configured to collect unburned gas from the burners 202. The vent assembly 200 may then be configured to vent or remove at least a portion of the collected unburned gas from the volume 110, which may be defined by the housing 102. The vent assembly 200 may accordingly improve safety of the cooking device 100. For instance, in circumstances in which a flame of the gas burner is unintentionally extinguished, the vent assembly 200 may collect at least a portion of gas introduced into the volume 110 after the flame is extinguished. The vent assembly 200 may then vent or remove at least a portion of the collected gas from the volume 110.

The vent assembly 200 may include one or more gutters 400A-400C (generally, gutter 400 or gutters 400). In an exemplary embodiment, one or more of the gutters 400 may be at least partially disposed in the housing 102 and at least a portion of the gutters 400 may be positioned below at least a portion of the gas burners 202. For instance, a first burner 202A may be positioned between a first heat tent 204A and a first gutter 400A. The first burner 202A may be above (e.g., displaced in a y-direction) the first gutter 400A. Generally, propane and some other gases used in cooking devices, such as cooking device 100, are heavier than air. Accordingly, unburned propane or other gases may exit the first burner 202A and then fall or sink into an inner volume of the first gutter 400.

In the exemplary embodiment shown in FIGS. 2A and 2B, the vent assembly 200 may include one gutter 400 positioned below each of the burners 202. Each of the gutters 400 may accordingly collect unburned gas from one of the burners 202. In other exemplary embodiments, the vent assembly 200 may include one gutter that is placed below or positioned relative to two or more burners 202. For instance, one gutter 400 may be positioned below the first burner 202A and a second burner 202B. Additionally, in some exemplary embodiments, more than one of the gutters 400 may be positioned relative to one of the burners 202. For instance, in some exemplary embodiments two or more gutters 400 may be positioned below the first burner 202A. The two or more gutters 400 may be positioned next to one another or displaced relative to one another in the first direction 108. After reviewing this disclosure one of ordinary skill in the art will appreciate that the vent assembly 200, the burners 202, the gutters 400, and other components of the cooking device 100 may have different shapes, sizes, configurations, and arrangements depending, for example, upon the intended use of the cooking device 100.

The vent assembly 200 may include a vent 214. The vent 214 may be configured to enable gas collected in the gutter 400 to exit the volume 110 and the housing 102. For example, the vent 214 may be positioned at an end of one or more of the gutters 400. For instance, in the exemplary embodiment shown in FIGS. 2A and 2B, the vent 214 may be defined or disposed in a rear wall 216 of the housing 102. The vent 214 may be fluidly coupled to the gutter(s) 400 such that the collected gas may flow along the gutter 400 and exit the housing 102 via the vent 214. After the collected gas exits the volume 110 and/or the housing 102, a risk of explosion or sudden combustion may be reduced.

The gutter 400 may be configured or arranged relative to the vent 214 to enable passive removal of the collected gas. For instance, with reference to FIG. 2B, the gutter 400 may be sloped to enable the collected gas to seep out of the volume 110 via the vent 214. In the depicted embodiment, the gutter 400 may be sloped from a front wall 218 of the housing 102 to the rear wall 216 of the housing 102. In particular, in the exemplary embodiment shown in FIG. 2B, the gutter 400 may be positioned below a front part of the burner 202. The gutter 400 and the burner 202 may extend towards the rear wall 216. As the gutter 400 extends to the rear wall 216, it may drop such that a distance between the burner 202 and the gutter 400 increases. The burner 202 may be substantially level or level between the front wall 218 and the rear wall 216.

In other embodiments, the gutter 400 may be sloped in another direction. For instance, the gutter 400 may extend to one or both sides of the volume 110 or the housing 102, or out a bottom portion of the volume or the housing 102. For instance, the vent 214 may be positioned on one side of the volume 110 or the housing 102, a curved lower portion of the volume 110 or the housing 102, or the like. Additionally, or alternatively, the gutter 400 may be implemented with one or more active or passive ventilation systems. For instance, the gutter 400 may be positioned by a fan or blower, which may actively push the collected gas from the gutter 400.

The vent assembly 200 may include a structure that directs gas exiting the housing 102 in a particular direction, such as away from the volume 110. For instance, in the exemplary embodiment shown in FIGS. 2A and 2B, the vent 214 may include one or more awnings 220. The awnings 220 may extend from a surface of the housing 102 such as the rear wall 216. The awnings 220 may direct the gas towards a plane on which the cooking device 100 is placed. For instance, the awnings 220 may direct the gas towards the ground or otherwise into an environment. It will be appreciated that the awnings 220 or other structure could direct the gas flow in any suitable directions and that the awnings 220 may not be required.

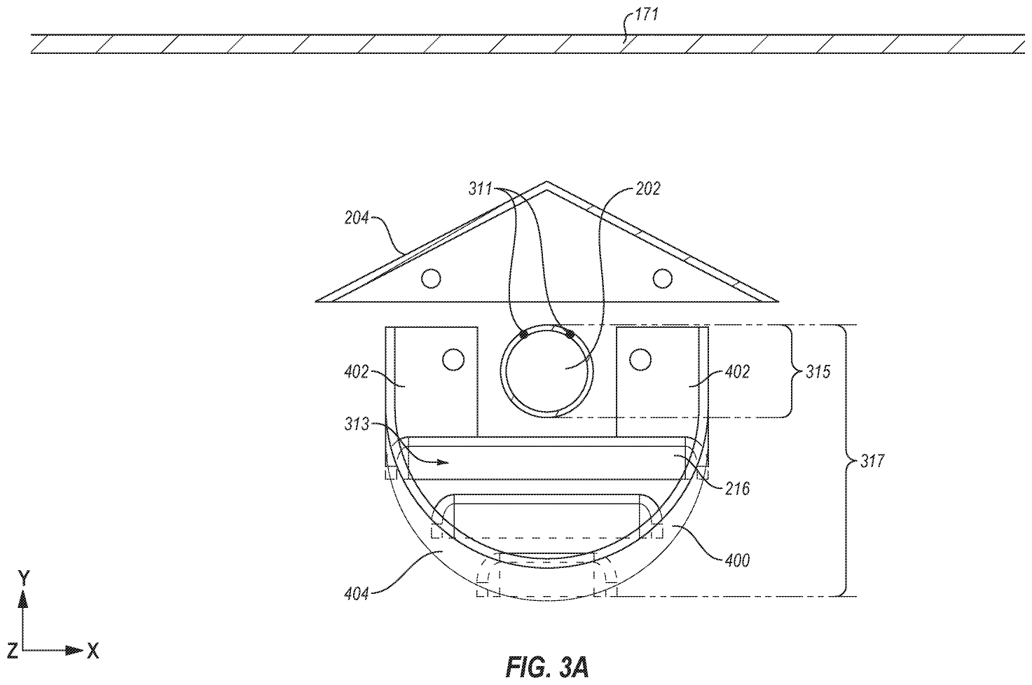

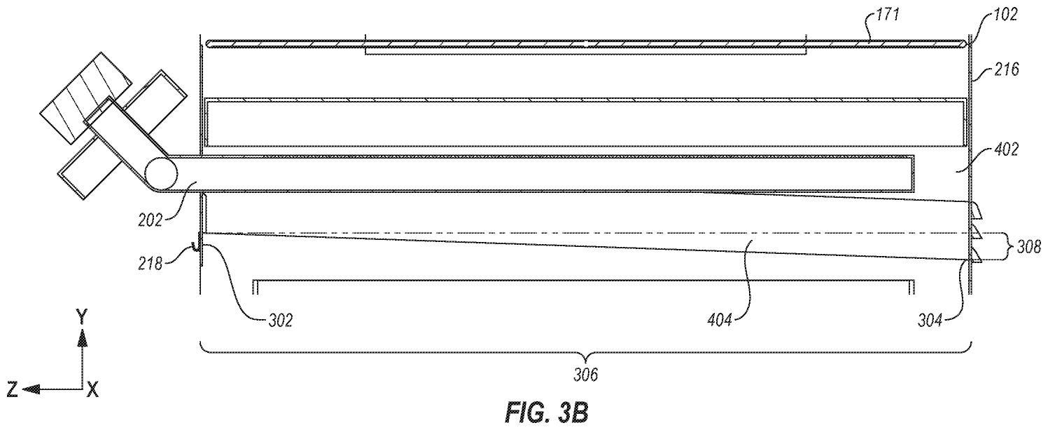

FIGS. 3A and 3B illustrate an example of a portion 300 of the vent assembly 200 shown in FIGS. 2A and 2B. The portion 300 may include one or more of gutters and one or more of the burners, such as the gutters 400 and burners 202 described with reference to FIGS. 2A and 2B. FIG. 3A is a cross-sectional view of the gutter 400 and the burner 202 shown relative to a portion of the cooking grid 171. The gutter 400 is shown as transparent and the rear wall 216 of FIGS. 2A and 2B is removed for clarity. It will be appreciated that the awnings 220 may be indicative of locations of openings defined in the rear wall 216. FIG. 3B is a sectional view showing a section across the exemplary burner 202. A sectional view of the gutter 400 is shown in FIG. 3B.

Referring to FIG. 3A, the gutter 400 may be at least partially positioned below the burner 202. As shown in the accompanying figures, the cooking grid 171 may be disposed above the heat tent 204, the heat tent 204 may be disposed above the burner 202, and the burner 202 may be disposed above at least a portion of the gutter 400. Additionally, the gutter 400 may be generally configured to be positioned around at least a portion of the burner 202. For instance, the burner 202 may be positioned such that the gutter 400 surrounds at least a majority of one or more of the side portions and/or bottom portions of the burner 202. In some exemplary embodiments, the burner 202 may include one or more gas apertures 311 via which a gas may exit the burner 202. The gutter 400 may be configured to extend past the gas apertures 311 (e.g., having a higher y-coordinate) such that unburned gas exiting the gas burner settles in the gutter 400.

In the exemplary embodiment shown in FIG. 3A, the gutter 400 may include a lower portion, such as a rounded portion 404, and one or more sides, such as linear portions 402. The burner 202 may be positioned between the linear portions 402. For instance, in some embodiments, the burner 202 may be centered or substantially centered between the linear portions 402. The burner 202 may have a burner height 315 and the gutter 400 may have a gutter height 317. The gutter height 317 may be between about 1.5 and about 3.2 times the burner height 315, and the gutter height could be larger or smaller if desired. In these and other exemplary embodiments, the gas may exit the burner 202 and be directed to settle in an inner volume 313 of the gutter 400, which may be at least partially defined by the rounded portion 404 and/or by the linear portions 402. Any unburned gas may settle into the inner volume 313 of the gutter 400 and move towards the awnings 220.

In addition, the gutter 400 may facilitate use of the burner 202 and/or may prevent the burner 202 from being inadvertently or unintendedly extinguished. The gutter 400 may also provide improved or more consistent airflow to the burner 202. In addition, the gutter 400 may reduce or prevent unintended airflow to the burner 202, or may reduce or prevent high airflow rates or sudden gust to the burner, which may prevent the burner 202 from being inadvertently or unintendedly extinguished. For instance, a heat source, such as the heat source 104, may include an axial fan and the fan may provide air to the wood pellet stove or burner. At least a portion of the airflow from the axial fan may be directed around the burner 202 by the gutter 400, which may reduce the likelihood of the air from the axial fan from extinguishing a flame of the burner 202.

In other exemplary embodiments, the burner 202 may be positioned higher or lower in the gutter 400. For instance, the gutter 400 may omit one or both linear portions 402. In these exemplary embodiments, the burner 202 may be positioned generally above the rounded portion 404. In yet other exemplary embodiments, the linear portions 402 may extend up past the burner 202 such that an upper most portion of the burner 202 is below an upper most portion of the gutter 400. After reviewing this disclosure, one of ordinary skill in the art will appreciated that the burners 202, the gutters 400, the linear portions 402, the rounded portions 404, and the like may have other suitable shapes, sizes, configurations, and/or arrangements depending, for example, upon the intended use of the cooking device 100.

Referring to FIG. 3B, in the depicted exemplary embodiments, the burner 202 may extend in the z-direction and may be disposed in a substantially level configuration. The burner 202 may remain disposed between the linear portions 402 as the rounded portion 404 of the gutter 400 may slope downwardly. For instance, at the front wall 218, a front lowest point 302 of the rounded portion 404 may be disposed in a higher position than a rear lowest point 304 of the rounded portion 404 at the rear wall 216. In some exemplary embodiments, a depth 306 of the housing 102 may be about twenty-four (24) inches. In these exemplary embodiments, a difference 308 between the front lowest point 302 and the rear lowest point 304 may be between about one-half (0.5) inches and about six (6.0) inches, between about one (1.0) inches and about three (3.0) inches, or about two and one-half (2.5) inches. In cooking devices in which the depth 306 is greater or less than about twenty-four (24) inches, the difference may be proportionally determined. After reviewing this disclosure, one of ordinary skill in the art will appreciate that the difference 308 may be smaller or larger depending, for example, upon the positioning of the burners 202, the gutter 400, the size of the volume 110 and/or the housing 102, and the like.

The gutter 400 may be attached to the rear wall 216. In particular, the gutter 400 may be attached to the rear wall 216 such that the openings corresponding to the awnings 220 are located within the gutter 400. This positioning may enable any accumulated gas to exit the gutter 400 via the vent 214. The gas may then enter an environment surrounding the cooking device 100. In some exemplary embodiments, the gutter 400 may not be attached to the rear wall 216. In these exemplary embodiments, the gutter 400 may at least contact the rear wall 216 to enable any accumulated gas to transition from the gutter 400 out the vent 214.

The gutter 400 may also be attached to the front wall 218. The attachment to the front wall 218 may help retain any accumulated gas in the gutter 400. For instance, the front wall 218 may help prevent the gas from spilling from the gutter 400. In other embodiments, the gutter 400 may not extend to the front wall 218. In these embodiments, the gutter 400 may include a front surface which may be positioned at some position between the front wall 218 and the rear wall 216. After reviewing this disclosure, one of ordinary skill in the art will apricate that the gutter 400 may be attached to any suitable portions of the housing 102 and/or the volume 110, but the gutter does not have to be attached to the housing 102 or the volume 110.

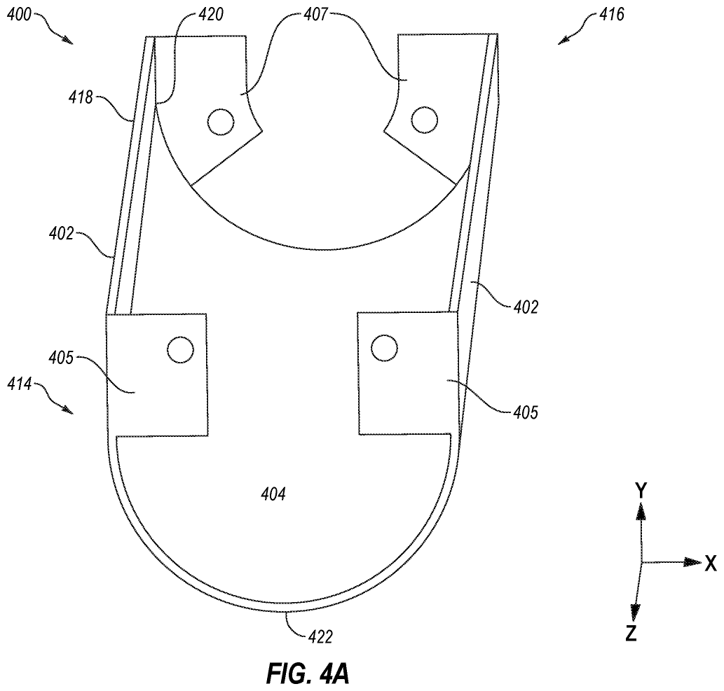

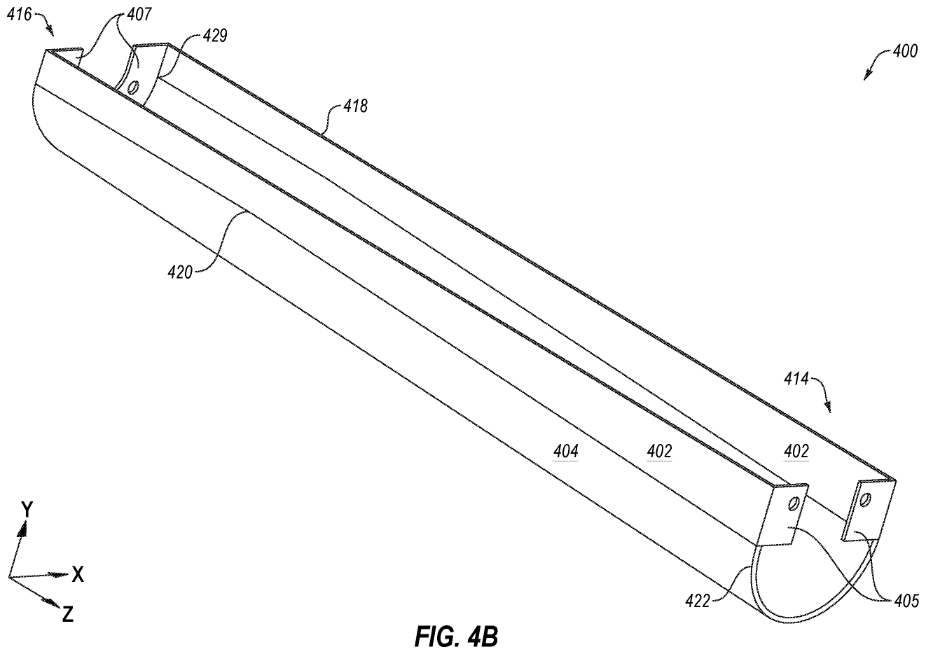

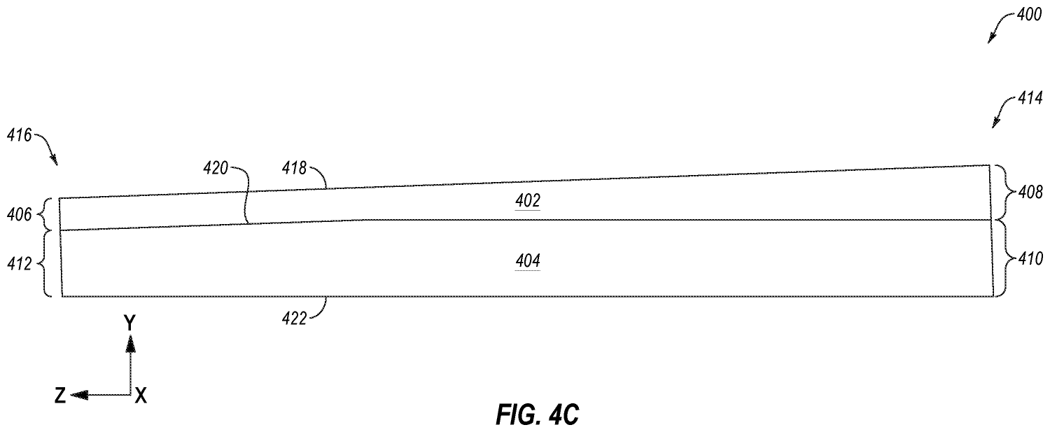

FIGS. 4A-4C illustrate an example embodiment of the gutter 400. FIG. 4A depicts an end view of the gutter 400, FIG. 4B depicts a first perspective view of the gutter 400, and FIG. 4C depicts a side view of the gutter 400. The gutter 400 of FIGS. 4A-4C may be implemented in the unburned gas vent assembly 200 described with reference to FIGS. 2A-3B. The gutter 400 may be configured to receive unburned gas or some portion thereof and transfer or enable transfer of the unburned gas from a housing such as the housing 102 of FIGS. 1A and 1B. The exemplary embodiment shown in FIGS. 4A-4C is positioned relative to (e.g., below or at least partially below) a gas burner such that unburned gas, which may be heavier than air, may settle or fall into the gutter 400. The gutter 400 may collect the unburned gas and enable the gas to transfer from the housing out a vent or another suitable opening or ventilation subsystem.

The exemplary gutter 400 illustrated in FIGS. 4A-4C may include a first end 416 and a second end 414. The first end 416 and the second end 414 may be opposite one another. Between the first end 416 and the second end 414, the gutter 400 may include one or more sides, such as the linear portions 402, and a bottom portion, such as the rounded portion 404. In the exemplary embodiment shown in FIGS. 4A-4C, the rounded portion 404 may include two ends that run along one or more seams 420. The linear portions 402 may be attached to the rounded portion 404 along the ends. For instance, a first linear portion 402 may extend from a first end of the rounded portion 404 and a second linear portion 402 may extend from a second end of the rounded portion 404.

In other embodiments, the gutter 400 may include other suitable shapes, sizes, configurations, and/or arrangements. For instance, the gutter 400 may include only the rounded portion 404 (e.g., omit the linear portions 402), a rectangular structure, a triangular or angled structure (e.g., two or more linear portions that meet at one or more apexes), etc.

The gutter 400 may include one or more attachment features, such as attachments features 405 and 407. For instance, the gutter 400 may include front attachment features 407. The front attachment features 407 may extend from a front perimeter 429 towards one another. In detail, the front attachment features 407 may extend from a portion of the front perimeter 429 that may include ends of the linear portions 402 and may include some part of the rounded portion 404.

The gutter 400 may also include rear attachment features 405. The rear attachment features 405 may extend from a rear perimeter 422 towards one another. In detail, the rear attachment features 405 may extend from a portion of the rear perimeter 422 that may include ends of the linear portions 402.

Referring to FIG. 4C, an example of a sloped structure of the gutter 400 is depicted. As introduced above, the gutter 400 may be configured to slope or be slanted from a first portion of a cooking device to a second portion of the cooking device. For example, with combined reference to FIGS. 3B and 4C, the gutter 400 may slope from the front wall 218 to the rear wall 216.

In the exemplary embodiments of FIGS. 3B and 4C, the gutter 400 may include a cross-section that includes a gradient. For instance, a radius of the rounded portion 404 may increase from the first end 416 at which the gutter 400 is attached to the front wall 218 to the second end 414 at which the gutter 400 is attached to the rear wall 216. Additionally, or alternatively, a height of the linear portions 402 may be defined between the seam 420 and a top edge 418. The height of the linear portions 402 may increase from the first end 416 to the second end 414. For instance, with reference to FIG. 4C, a front linear portion height 406 may be less than a rear linear portion height 408. Additionally, or alternatively, a front rounded portion height 412 may be less than a rear rounded portion height 410.

In other exemplary embodiments, the gutter 400 may include a substantially consistent cross-section. In these embodiments, the gutter 400 may be attached to the housing 102 such that the gutter 400 slopes in a downward direction, which may be a negative y-direction and away from the cooking grid 171.

As discussed above, the cooking device 100 may include one or more components, such as the vent assembly 200, the gutter 400, and the like. These and other components may have various shapes, sizes, configurations, and/or arrangements depending, for example, upon the size and configuration of the cooking device 100. While the cooking device 100 may include one or more components, it will be appreciated after reviewing this disclosure that these components may not be required, and other suitable components may be used in connection with the cooking device 100.

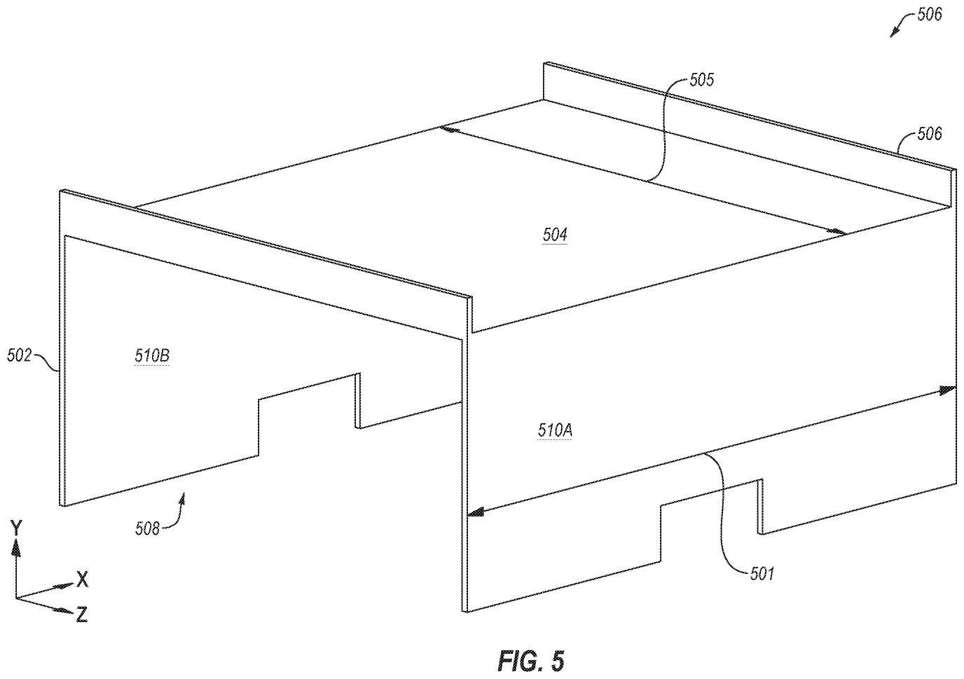

FIG. 5 illustrates an example embodiment of a heat diffuser 500 and the heat diffuser may be implemented in a cooking device, such as the cooking device 100 shown in FIGS. 1A and 1B or another suitable cooking device. The heat diffuser 500 may be configured to spread, direct, dissipate, and/or distribute heat, smoke, heated gas, and the like. For example, the heat diffuser 500 may include a substantially rectangular channel 508. In the exemplary embodiment shown in FIG. 5, the heat diffuser 500 may include a top 504 and two sides 510A and 510B, which may create at least a portion of the channel 508. A heat source may be positioned within the channel 508. Heat, heated gas, and/or smoke may be routed by the heat diffuser 500, such as out a front opening and/or a rear opening of the channel 508. For example, without the heat diffuser 500, heat, heated gas, and/or smoke may simply move in a direction that corresponds to a y-direction or towards a cooking grid (e.g., the cooking grid 171 such as shown in FIGS. 1A and 1B). Such heat transfer may result in one or more thermal concentrations or hot spots. The heat diffuser 500 may spread, direct, dissipate, and/or distribute the heat to a larger volume or area, which may reduce thermal concentration or hotspots.

With combined reference to FIGS. 2A, 2B, and 5, the channel 508 may be sized and configured to at least partially surround a heat source such as the heat source 104. The heat diffuser 500 may include a length 501 (such as shown in FIGS. 2A and 5). The length 501 may be greater than about one-third of a length 503 of the housing 102 and less than one-half the length 503 of the housing 102. The heat diffuser 500 may also include a width 505 (such as shown in FIGS. 2B and 5). The width 505 may be about one-half a width 507 of the housing 102. The heat diffuser 500 may be configured to direct heat, smoke and/or heated gas into one or more desired directions or locations, such as towards a left and/or a right portion of the housing 102 from a central portion of the housing 102. The heat diffuser 500 may be configured to diffuse the heat, heated gas, and/or smoke produced by the heat source 104 throughout at least a majority of the housing 102. Moreover, the heat diffuser 500 may lower the flow rate of heat, heated gases, and/or smoke leaving the heat source 104. The heat diffuser may also diffuse the heat, heated gas, and/or smoke throughout the volume 110. The heat diffuser 500 may accordingly reduce an amount and/or a velocity of moving fluids that may contact the burners 202.

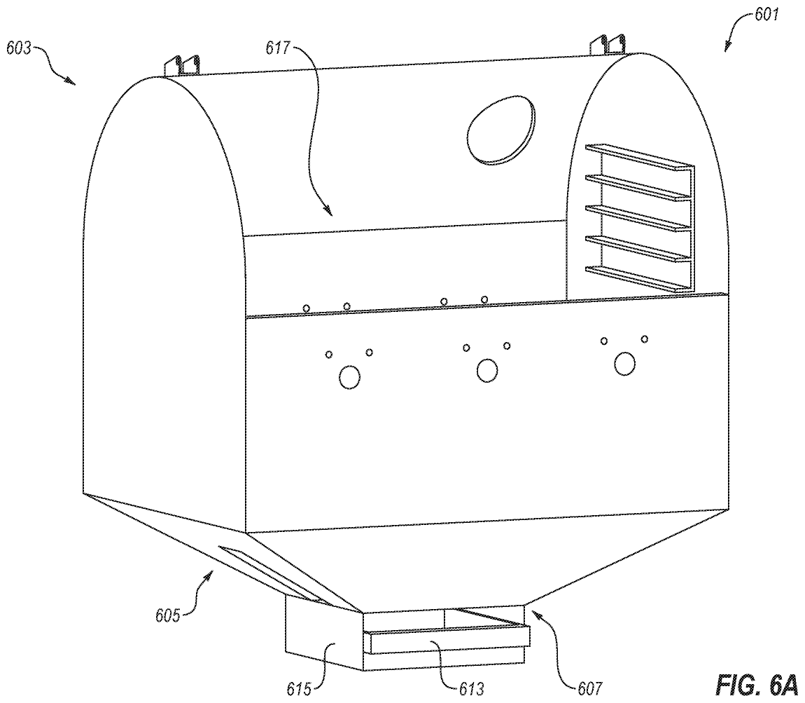

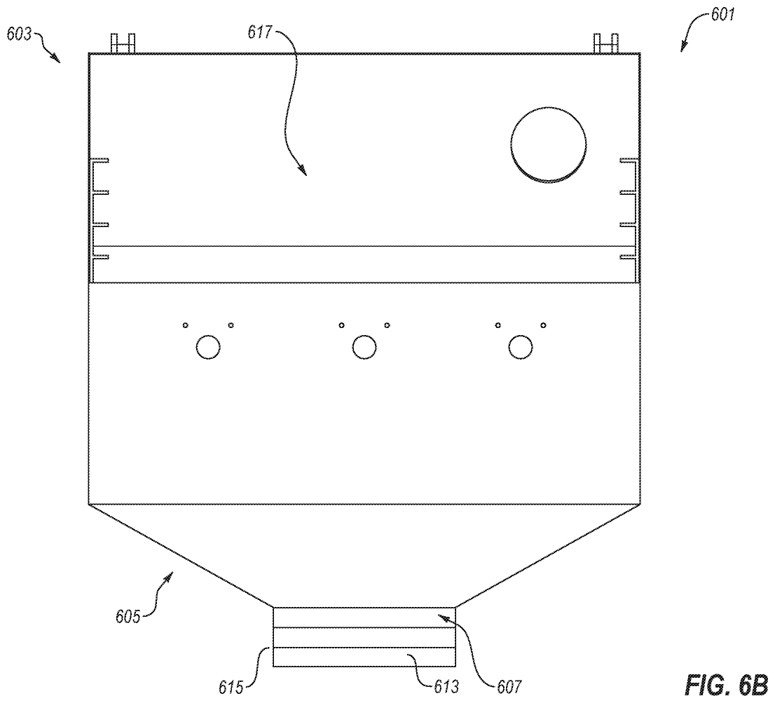

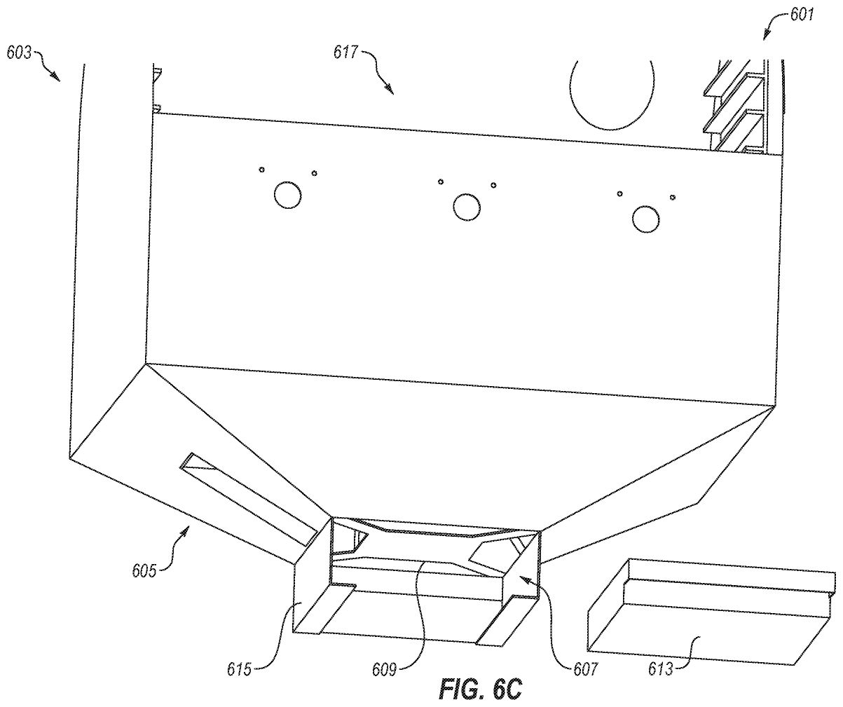

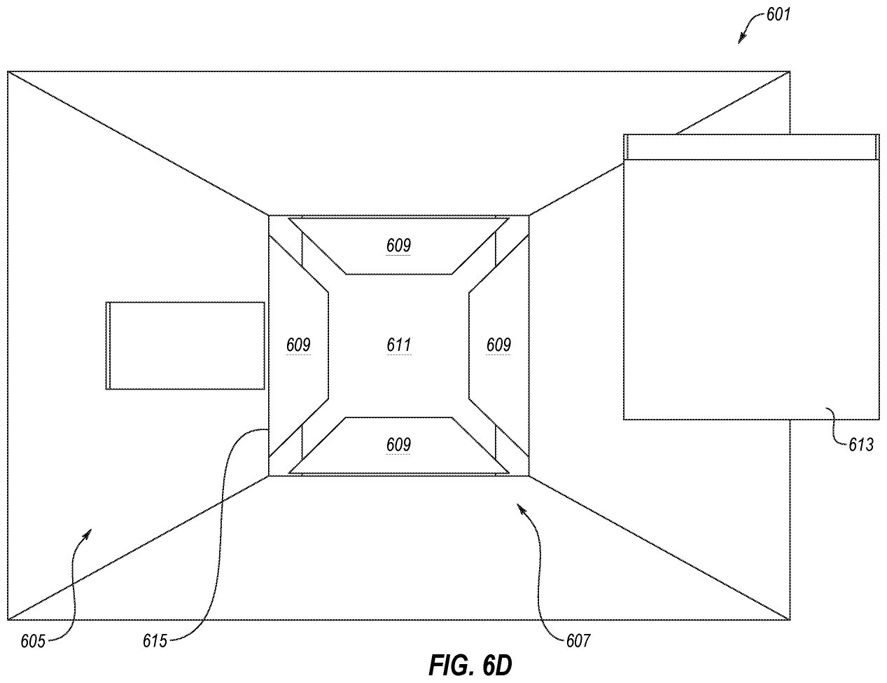

FIGS. 6A-6D illustrate an example vented housing 601 and the vented housing may be implemented in a cooking device, such as the cooking device 100 shown in FIGS. 1A and 1B or another suitable cooking device. For example, the vented housing 601 may be substituted for the housing 102 shown in FIGS. 1A and 1B. Additionally, the vented housing 601 may be implemented in cooking devices that include only one heat source, such as the heat source 104 or the heat source 106.

For instance, the vented housing 601 may be implemented in wood pellet cooking devices. Some examples of wood pellet cooking devices may include a single heat source, which may include the wood pellet stove described with reference to FIGS. 1A and 1B. These wood pellet cooking devices may include the auger conduit 602 that supplies wood pellets from a reservoir or another suitable arrangement. In these and other exemplary embodiments, the vented housing 601 may function as described below and may provide one or more benefits, and these benefits may apply to a wood pellet cooking device.

FIG. 6A is a perspective view of the vented housing 601. FIG. 6B is a front view of the vented housing 601. FIG. 6C is a lower perspective view of the vented housing 601. FIG. 6D is a bottom view of the vented housing 601. In FIGS. 6A-6D, the vented housing 601 is depicted without the other components (e.g., 104, 106, 400, 600, 216, 175, 191, 113, 602, 181, etc.). It may be appreciated with the benefit of the present disclosure that some or all the components may be incorporated in or with the vented housing 601 but none of these components may be required.

The vented housing 601 may include an upper portion 603 and one or more lower portions 605. As shown in the accompanying figures, the lower portions 605 may be sloped. The upper portion 603 may be substantially similar to an upper portion of the housing 102 shown in FIGS. 1A and 1B. The sloped lower portions 605 may include sloped surfaces angled towards a bottom vent subassembly (bottom vent) 607. The bottom vent 607 may include one or more apertures 609 (such as shown in FIGS. 6C and 6D). The apertures 609 may surround a pellet stove support 611 (such as shown in FIGS. 6C and 6D). The pellet stove support 611 may be attached the sloped lower portion 605 and may support a wood pellet stove, such as the wood pellet stove described with reference to FIGS. 1A and 1B.

In this exemplary embodiment, the bottom vent 607 may include four apertures 609 that are substantially centered in the sloped lower portions 605. In other embodiments, the bottom vent 607 may include more than four or fewer than four apertures 609. Additionally, or alternatively, the bottom vent 607 may be located at another location relative to the sloped lower portions 605. For instance, the bottom vent 607 may be located near one of the edges of the vented housing 601.

The apertures 609 may enable fluid transfer between an internal volume 617 of the vented housing 601 and a surrounding environment. For example, unburned gas that may not be caught in the gutters 400 described above may settle on inner surfaces of the sloped lower portion 605. The unburned gas may then exit the internal volume 617 via the apertures Accordingly, the vented housing 601 may provide added safety to cooking devices in which it is implemented. In addition, in some conventional cooking devices, a heat source such as a pellet stove may require significant air flow to light. Accordingly, in these cooking devices, a lid may be opened to light the stove. In contrast, in the vented housing 601, air may flow into the internal volume 617. The air may be used in ignition and combustion. The apertures 609 may surround the pellet stove support 611, which may enable the air to enter around a substantial portion of the pellet stove supported thereon.

In some embodiments introduced above, the vented housing 601 may be included in cooking devices that include a single heat source. In these embodiments, the vented housing 601 may enable air from a surrounding environment via the apertures 609. The air may supply necessary combustion materials during lighting of the single heat source. The air may enable a user to light the single heat source without opening a lid.

In some embodiments, an external tray 613 may be retained relative to the vented housing 102 and the external tray 613 may be retained via tray supports 615. The external tray 613 is shown exploded or spaced apart from the tray supports 615 in FIGS. 6C and 6D. The external tray 613 is shown placed on the tray supports 615 in FIGS. 6A and 6B. The external tray 613 may catch ash and coals from the wood pellet stove. In some embodiments, the external tray 613 may be omitted or the external tray 613 may have other shapes, sizes, configurations, and/or arrangements depending, for example, upon the size and configuration of the vented housing 601.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A cooking device comprising:
a housing;
a gas burner;
an unburned gas vent assembly comprising a gutter disposed in the housing and at least a portion of the gutter is disposed below at least a portion of the gas burner; and
a vent in fluid communication with an inner volume of the gutter to enable a gas disposed in the gutter to exit the housing via the vent.

2. The cooking device of claim 1, wherein:
the housing includes a first portion and a second portion;
the gas burner extends from the first portion of the housing to the second portion of the housing;
the vent is disposed in the second portion of the housing; and
the gutter is sloped from the first portion of the housing to the second portion of the housing.

3. The cooking device of claim 2, wherein the gutter comprises:
a rounded portion;
a first linear portion; and
a second linear portion; and
wherein the rounded portion is disposed below the gas burner.

4. The cooking device of claim 3, wherein:
a radius of the rounded portion increases from a first portion to a second portion; or
a height of the first linear portion and the second linear portion increases from the first portion to the second portion.

5. The cooking device of claim 3, wherein the gutter includes one or more attachment features.

6. The cooking device of claim 5, wherein the one or more attachment features includes rear attachment features that extend towards one another from the first and second linear portions.

7. The cooking device of claim 5, wherein the one or more attachment features includes front attachment features that extend towards one another from a portion of a front perimeter of the gutter that includes the first and second linear portions.

8. The cooking device of claim 3, wherein the gas burner is substantially centered between the first and second linear portions.

9. The cooking device of claim 1, wherein the vent includes an awning that extends from a surface of the housing and that directs the gas towards a plane on which the cooking device is placed.

10. The cooking device of claim 2, wherein the second portion of the housing directly contacts an end of the gutter such that gas is directed from the gutter to an environment outside the housing.

11. The cooking device of claim 1, wherein the gutter includes a height that is at least three times a height of the gas burner.

12. The cooking device of claim 1, further comprising a second heat source that is positioned below or directly below at least a portion of the gas burner and that is positioned within a volume defined by the housing.

13. The cooking device of claim 12, further comprising a heat diffuser, wherein the heat diffuser is positioned between the gutter and the second heat source and is configured to diffuse the heat produced by the second heat source throughout at least a portion of the housing.

14. The cooking device of claim 13, wherein:
the second heat source includes a wood pellet burner; and
the heat diffuser includes a substantially rectangular channel that partially surrounds the second heat source to direct smoke towards a left and a right portion of the housing from a central portion of the housing.

15. The cooking device of claim 14, wherein:
the heat diffuser includes a length that is greater than about one-third of a length of the housing and less than one-half the length of the housing; and
the heat diffuser includes a width that is about one-half a width of the housing.

16. The cooking device of claim 1, wherein the housing includes a vented housing including an upper portion and sloped lower portions defining a bottom vent subassembly.

17. The cooking device of claim 16, wherein the bottom vent subassembly includes one or more apertures that surround a pellet stove support, the apertures being configured to enable fluid transfer between an internal volume of the vented housing and a surrounding environment

18. The cooking device of claim 18, further comprising an external tray that is selectively retained relative to the vented housing via tray supports.

19. An unburned gas vent assembly for a cooking device that is configured to enable unburned gas to vent from a housing of the cooking device to an environment external to the housing, the assembly comprising:
a gutter configured to be disposed in the housing of the cooking device, at least a portion of the gutter disposed below at least a portion of a gas burner such that unburned gas exiting the gas burner settles in the gutter; and
a vent in fluid communication with an inner volume of the gutter to enable an unburned gas disposed in the gutter to exit the housing via the vent.

20. A cooking device comprising:
a vented housing including a bottom vent subassembly; and
one or more heat sources disposed in the vented housing,
wherein a first heat source includes a wood pellet stove and the vented housing enables fluid transfer from an internal volume defined by the vented housing and a surrounding the cooking device.
